(19) United States
(12) Patent Application Publication
(10) Pub. No.: US 2017/0119027 A1
(43) Pub. Date: May 4, 2017

(54) SYSTEM FOR REDUCING BACTERIA ON FOOD SURFACES WHILE EXTENDING SHELF LIFE

(71) Applicant: GROW GREEN INDUSTRIES, INC., Lake Forest, CA (US)

(72) Inventors: Mareya Shawki Ibrahim, Aliso Viejo, CA (US); Shawki Amin Ibrahim, Fort Collins, CO (US)

(21) Appl. No.: 15/293,135

(22) Filed: Oct. 13, 2016

Related U.S. Application Data
(63) Continuation of application No. 14/579,155, filed on Dec. 22, 2014.
Application No. 14/579,155 is a continuation of application No. 13/544,139, filed on Jul. 9, 2012, now abandoned.
Application No. 13/544,139 is a continuation of application No. PCT/US2012/023895, filed on Feb. 4, 2012.
Application No. PCT/US2012/023895 is a continuation-in-part of application No. 13/020,874, filed on Feb. 4, 2011, now Pat. No. 8,338,347.
(60) Provisional application No. 61/381,074, filed on Sep. 9, 2010.

(51) Int. Cl. A23L 3/3589; A23L 3/3472; A23L 3/3481; A23L 3/3508; A23B 4/20; A23B 7/154; A01N 37/36; A01N 37/06; A01N 43/16; A01N 65/36; A01N 59/02; A01N 41/04; A01N 31/02; A01N 59/08; A01N 59/00; A01N 25/02; A23L 3/3463

(52) U.S. Cl. CPC A23L 3/3589; A23L 3/34635; A23L 3/3472; A23L 3/3481; A23L 3/3508; A23B 4/20; A23B 7/154; A01N 37/36; A01N 37/06; A01N 43/16; A01N 65/36; A01N 59/02; A01N 41/04; A01N 31/02; A01N 59/08; A01N 59/00; A01N 25/02; A23V 2002/00; B05B 11/30

(57) ABSTRACT

A synergistic system for substantially reducing surface contaminants of a food and inhibiting yeast, mold and bacteria growth in a food, beverage or food grade cosmetic preparation comprising a substantially transparent and odorless solution made from a plurality of substantially organic compounds selected from: citric acid, sodium citrate, vegetable glycerin, sea salt, potassium sorbate, decyl glucoside, calcium ascorbate, grapefruit seed extract, quillaja saponin, calcium carbonate, ascorbic acid, sodium percarbonate and sodium bisulfate, and an applicator for applying the solution to the food substance.

### CROSS-REFERENCE TO RELATED APPLICATIONS

This application is a continuation of U.S. patent application Ser. No. 14/579,155, filed 22 Dec. 2014, which is a continuation of U.S. patent application Ser. No. 13/544,139, filed 9 Jul. 2012, now abandoned, which is a continuation of PCT Application No. PCT/US2012/023895, filed on 4 Feb. 2012, which is a continuation-in-part of U.S. patent application Ser. No. 13/020,874, filed 4 Feb. 2011, now U.S. Pat. No. 8,338,347, which is based on U.S. Provisional Application No. 61/381,074, filed 9 Sep. 2010, of which are hereby incorporated by reference in their entireties.

### BACKGROUND OF THE INVENTION

### Field of the Present Disclosure

The invention relates to a system of substantially reducing bacteria, yeast, mold, food borne illness causing organisms and other contaminants in food and on food surfaces, primarily fresh produce, seafood, poultry, beverages, food preparations and food based cosmetic applications, while simultaneously extending shelf life, reducing spoilage, bacteria and mold growth by applying an antimicrobial, antioxidant solution made from all natural compounds to the food surface, the ingredient deck of a prepared food or a food-grade cosmetic or oral care product. The system is applied via a liquid solution or a biodegradable wipe treated with the solution. The wipes do not require rinsing. The system may also be applied via solid form such as a powder or tablet. The powder or tablet may be made with effervescent ingredients and may dissolve readily in water or other liquid, including but not limited to the natural moisture of the food substance. The powder may be mixed directly into food as a natural additive if there is sufficient moisture content to distribute the powder effectively throughout. The powder may also be reconstituted and applied as a liquid soak, dip or spray to the surface of foods as a sanitizer or incorporated into a recipe to extend shelf life.

Food borne illnesses are an increasing concern in homes across the country. These illnesses are present in part because the foods being sold at grocery stores are grown in organic soil and manure and treated with pesticides and chemicals, then are covered with non-water soluble wax, which can make foods dangerous to consumers upon ingestion. Additionally, these illnesses are sometimes spread when food is not preserved, washed or stored properly, causing the microorganisms, bacteria, dirt, or other particles naturally found in or on the food to be ingested. While consumers are generally aware of the risks of food borne illnesses, they nonetheless fail or are unable to effectively remove the chemicals and bacteria that is the cause.

Waste of fresh foods is one of the leading causes of methane emissions in landfills. According to the U.S. Department of Agriculture, Fresh fruits and vegetables accounted for nearly 20 percent of consumer and foodservice losses. Methane gas from fresh fruit and vegetables is considered 21 times more harmful than carbon dioxide. The environmental impact of this waste affects the global economy.

Most consumers simply wash foods with plain water, however this method generally fails to effectively bring harmful chemicals and bacteria to a safe level for human consumption. Furthermore, water is generally ineffective at removing protective wax from fruits and/or vegetables. Other food wash solutions with chemical compounds are also available. These chemicals are often harsh smelling, turbid, and leave a residue that affects the taste of the food or unsafe if ingested. Solutions are available that are effective in reducing bacteria and pesticide content, and that do not leave a chemical residue; however these washes are generally a disinviting color and are accompanied by a bad taste, both of which discourage usage. Often, their efficacy in food service or manufacturing/processing is limited and may be dangerous. Some are made of chemicals potentially linked to cancer, hyperactivity and other harmful side effects. Some do not allow manufacturers to reach the shelf life they are seeking, while controlling microorganism growth adequately.

As food surface sanitizing product, there is a very strong demand in the organic produce industry to identify safe, effective alternatives to the widespread use of chlorine as a microbial control. Likewise, the food industry is actively seeking all natural, effective products for their customers who are asking for natural, non-allergenic treatment of food.

A powerful, safe, concentrated, quick and evenly dissolving powder and tablet solution eliminates the need to transport water, which is costly and often inefficient, while adding additional stability and shelf life. Additionally, the end user can use the products in an infinite number of varying concentrations to meet their specific needs.

It is therefore desirable for an organic food wash solution that is substantially odorless, colorless, tasteless and safe, and which can be easily produced at low cost and effort, and which may be used on fresh produce, seafood, poultry, legumes, nuts and other raw ingredients prone to microorganisms, yeast or mold.

### BRIEF SUMMARY OF THE INVENTION

The primary objective of this invention is to provide an all-natural solution that is easily produced without resort to dangerous or artificial chemicals or heat, and which can remove dirt, pesticides, chemicals and odors, and which can reduce oxidation and spoilage of fresh food, without leaving a residual chemical taste or smell.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention. In such drawing(s):

FIG. 1 illustrates a preferred order that organic compounds are dissolved according to a preferred embodiment.

### DETAILED DESCRIPTION OF THE INVENTION

The above described drawing FIGURES illustrate the described solution and its method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

A system 100 for substantially reducing surface bacteria of a food substance comprises: a solution 120 of a plurality of substantively organic compounds dissolved in water, and an applicator 110 for applying the solution to the food substance. The solution is substantially transparent, tasteless and odorless. The applicator may be a wipe, towelette, sponge, spray bottle or any other type of applicator operable to apply the solution to a surface of the food substance.

In a preferred embodiment, the solution preferably consists of a plurality of all natural compounds. A first compound is operable to substantially kill bacteria, remove wax, and inhibit browning, and is preferably citric acid. A second compound is operable to substantially increase bacteria kill efficacy and prolong shelf life, and is preferably sodium citrate. A third compound is operable to substantially increase bacteria kill efficacy and prolong shelf life, and is preferably sea salt. A fourth compound is operable to facilitate adherence of the solution to a food surface and is preferably vegetable glycerin. A fifth compound is operable to preserve a substantially transparent color in the solution, and to substantially prevent mold and bacteria growth, and is preferably potassium sorbate. A sixth compound is operable to facilitate the removal of mud, fat soluble contaminants, pesticide residue and the like, and is preferably decyl glucoside or cocamidopropyl hydroxysultaine. A seventh compound is operable to substantially inhibit browning, and is preferably calcium ascorbate.

In a preferred embodiment, the solution preferably consists of a plurality of substantively organic compounds selected from: citric acid, sodium citrate, vegetable glycerin, sea salt, decyl glucoside, cocamidopropyl hydroxysultaine, calcium ascorbate, potassium sorbate, grapefruit seed extract, and sodium bisulfite. The compounds are preferably dissolved in distilled, deionized or triple filtered water.

In a preferred embodiment, the solution comprises approximately: 2% to 4% citric acid, 2% to 4% sodium citrate, 0.2% to 1.4% vegetable glycerin, 0.2% to 0.4% potassium sorbate; 0% to 0.8% decyl glucoside, 0% to 0.2% calcium ascorbate, 0% to 0.2% grapefruit seed extract, 0% to 0.1% sodium bisulfate, and 0.2% to 2% to 4% sea salt. The compounds are preferably dissolved in deionized or triple filtered water to produce the solution.

In one embodiment, the solution consists of: 93.6% water, 2% citric acid, 2% sodium citrate, 2% sea salt, 0.2% vegetable glycerin and 0.2% potassium sorbate. In the system of the present embodiment, the solution is preferably applied to seafood and poultry via a spray applicator. Alternatively, the solution may be applied to fruit and vegetables via towlette applicators.

In an alternative embodiment, the solution consists of: 93.1% water, 2% citric acid, 2% sodium citrate, 2% sea salt, 0.2% vegetable glycerin, 0.2% potassium sorbate, 0.4% decyl glucoside, and 0.1% calcium ascorbate. In the system of the present embodiment, the solution is preferably applied to fruits and vegetables via a spray applicator.

In an alternative embodiment, the solution consists of 87.4% water, 4% citric acid, 4% sodium citrate, 4% sea salt, 0.4% vegetable glycerin and 0.2% potassium sorbate.

In another embodiment, the solution consists of: 86.2% water, 4% citric acid, 4% sodium citrate, 4% sea salt, 0.4% vegetable glycerin, 0.4% potassium sorbate, 0.8% decyl glucoside, and 0.2% calcium ascorbate.

In an alternative embodiment, the solution consists of: 95.2% water, 2% citric acid, 2% sodium citrate, 0.2% sea salt, 0.2% vegetable glycerin, 0.2% potassium sorbate, and 0.2% calcium ascorbate.

In an alternative embodiment, the solution consists of: 95% distilled water, 2% citric acid, 2% sodium citrate, 0.2% sea salt, 0.2% vegetable glycerin, 0.2% potassium sorbate, 0.2% decyl glucoside, and 0.2% calcium ascorbate.

In an alternative embodiment the solution consists of: 95.2% distilled water, 2% citric acid, 2% sodium citrate, 0.2% grapefruit seed extract, 0.2% vegetable glycerin, 0.2% potassium sorbate, and 0.2% calcium ascorbate.

In an alternative embodiment, the solution consists of: 95.2% distilled water, 2% citric acid, 2% sodium citrate, 0.2% sodium bisulfate, 0.2% vegetable glycerin, 0.2% potassium sorbate, and 0.2% calcium ascorbate.

The combination of the all-natural compounds according to the preferred methods described below preferably results in the solution being substantially transparent, tasteless and odorless.

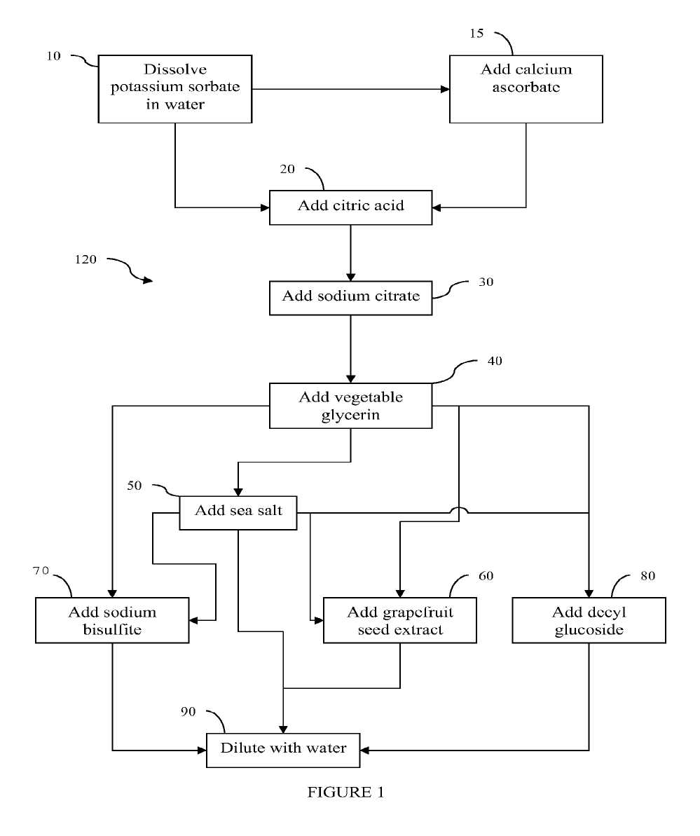

The advantage of the present solution may be accomplished by the order that the compounds are dissolved in the solution. FIG. 1 illustrates the preferred order of dissolution of the compounds. In each of the below steps, the compounds being added according to the step is preferably dissolved until a clear solution results. Furthermore, the dissolution of the organic compounds is preferably accomplished at or near room temperature.

The first organic compound, potassium sorbate 10, is dissolved in an initial portion of the water until a clear solution results. After a clear solution results, the citric acid 20 is dissolved in the solution until clear. In some embodiments, an intermediate step is conducted between the dissolution of potassium sorbate and the dissolution of the citric acid. The intermediate step is the step of dissolving the calcium ascorbate 15 in the potassium sorbate solution until the solution is again clear.

Next, the sodium citrate is dissolved in the solution until the solution is clear 30. Then, the vegetable glycerin 40 is added to the solution and dissolved until clear.

Subsequently, at least one of: the sea salt 50, the grapefruit seed extract 60, the sodium bisulfite 70, and the decyl glucoside 80 is added to the solution and dissolved until clear.

In some embodiments, the sea salt is added to the solution and dissolved until clear, and then at least one of: sodium bisulfite, decyl glucoside, and grapefruit seed extract is added to the solution and dissolved until clear.

In some embodiments, exactly one of: the sea salt, the sodium bisulfite, the decyl glucoside, and the grapefruit seed extract is added to the solution and dissolved until clear.

In some embodiments, the decyl glucoside may be replaced with cocamidopropyl hydroxysultaine.

Finally, a remaining portion of the water 90 is added to the solution.

In an alternative embodiment, the system comprises a concentrated solution consisting of: 58.5% water, 20% citric acid, 10% sodium citrate, 10% cocamidopropyl hydroxysultaine, 1% glycerin, and 0.5% calcium ascorbate.

According to the present embodiment, the solution is prepared according the following steps:

First, the citric acid is dissolved in substantially all of the water and mixed until a clear solution is produced. Second, the sodium citrate is added to the solution and mixed until the solution is again clear. Third, the cocamidopropyl hydroxysultaine is added to the solution and mixed until the solution is again clear. Finally, the calcium ascorbate is dissolved separately in a remaining portion of the water to form an ancillary solution and the ancillary solution is mixed to the clear solution.

In at least one embodiment, the solution 120 comprises: a solute 130 of a plurality of substantively organic compounds, and a solvent 140.

The solute 130 is preferably a substantially homogeneous powder comprising a plurality of all natural compounds. The solute 130 may be in the form of a powder or a tablet. A first compound is operable to substantially kill bacteria, remove wax, and inhibit browning, and is preferably citric acid. A second compound is operable to substantially increase bacteria kill efficacy and prolong shelf life, and is preferably sodium citrate. A third compound is operable to substantially increase bacteria kill efficacy and prolong shelf life, and is preferably sea salt. A fourth compound is operable to facilitate adherence of the solution to a food surface and is preferably vegetable glycerin. A fifth compound is operable as an oxidizer to enhance antimicrobial efficacy, and is preferably sodium percarbonate. A sixth compound is an antioxidant operable to enhance shelf life, and is preferably ascorbic acid. A seventh compound is a non-allergenic surfactant operable to lift non-water soluble agents like wax, pesticides and soils, contains antimicrobial properties and is preferably quillaja saponin. An eighth compound is a mineraloperable to enhance efficacy of the sixth compound, and is preferably calcium carbonate. One or more of these compounds may be combined to form the solute 130.

In at least one embodiment, the solute 130 comprises, by weight: 2.4 g of citric acid, 1.2 g of sodium citrate, 1.2 g of quillaja saponin, 0.090 g of ascorbic acid, 0.035 g of calcium carbonate, and 0.075 g of vegetable glycerin.

In at least one embodiment, the solute 130 comprises, by weight: 2.4 g of citric acid, 1.2 g of sodium citrate, 1.2 g of quillaja saponin, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 1.2 g of citric acid, 1.2 g of sodium citrate, 1.2 g of sodium percarbonate, 1.2 g of quillaja saponin, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of quillaja saponin, 18 g of ascorbic acid, 7 g of calcium carbonate, and 15 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of sodium percarbonate, 18 g of ascorbic acid, 7 g of calcium carbonate, and 15 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of sea salt, 18 g of ascorbic acid, 7 g of calcium carbonate, and 15 g of vegetable glycerin. It should be understood that the ratios of the compounds may remain constant while specific amounts may vary.

In at least one embodiment, the solute 130 comprises, by weight: 480 g of citric acid, 480 g of sodium citrate, 33 g of ascorbic acid, and 7 g of calcium carbonate. It should be understood that the ratios of the compounds may remain constant while specific amounts may vary.

In at least one embodiment, the solute 130 comprises, by weight: 480 g of citric acid, 240 g of sodium citrate, 240 g of sea salt, 26 g of ascorbic acid, and 14 g of calcium carbonate. It should be understood that the ratios of the compounds may remain constant while specific amounts may vary.

In at least one embodiment, the solute 130 comprises, by weight: 2.4 g of citric acid, 1.2 g of sodium citrate, 1.2 g of sea salt, 1.2 g of quillaja saponin, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 2.4 g of citric acid, 1.2 g of sodium citrate, 1.2 g of sea salt, 0.165 g of ascorbic acid, and 0.035 g of calcium carbonate. It should be understood that the ratios of the compounds may remain constant while specific amounts may vary.

In at least one embodiment, the solvent 140 is preferably water or other liquid. The solvent 140 may also be the natural moisture of food stuff.

In at least one embodiment, the solute 130 is generated by blending the plurality of compounds according to their specific gravities and granular size. In some embodiments, the order of blending may be citric acid, sea salt, quillaja, sodium percarbonate, sodium citrate and vegetable glycerin. In some embodiments, a centrifugal blender may be used to generate the solute 130 from the compounds. Each compound may be added in sequence and blended until the solute is of a uniform composition. The blending in of a subsequent compound may last between 5 and 180 minutes.

In at least one embodiment, the solute is a tablet that may be formed using known tablet making processes.

The solute 130 may be added to the solvent 140 to form the solution 120. In this manner, the solute 130 may be transported inexpensively and conveniently in solid form as opposed to liquid form. Thus, the solution 120 may be generated with minimal effort.

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A system for reducing food borne illness comprising:
a solution consisting of a plurality of substantially organic compounds and water; and
an applicator for applying the solution to a surface of a food substance;
wherein the solution is substantially transparent.

2. The system of claim 1, wherein the compounds are selected from: citric acid, sodium citrate, vegetable glycerin, sea salt, potassium sorbate, decyl glucoside, calcium ascorbate, grapefruit seed extract, sodium bisulfate, cocamidopropyl hydroxysultaine, and glycerin.

3. The system of claim 2, wherein the solution comprises approximately: 92.7% to 95.4% water, 2% citric acid, 2% sodium citrate, 0.2% vegetable glycerin, 0.2% potassium sorbate; 0% to 0.4% decyl glucoside, 0% to 0.2% calcium ascorbate, 0% to 0.2% grapefruit seed extract, 0% to 0.1% sodium bisulfate, and 0.2% to 2% sea salt.

4. The system of claim 1, wherein the solution consists of: 58.5% water, 20% citric acid, 10% sodium citrate, 10% cocamidopropyl hydroxysultaine, 1% glycerin, and 0.5% calcium ascorbate.

5. The system of claim 1, wherein the solution is substantially odorless.

6. The system of claim 1, wherein the applicator comprises a towelette.

7. The system of claim 1, wherein the applicator comprises a spray bottle.

8. A system for reducing food borne illness comprising:
a solute consisting of a substantially homogeneous mixture of substantially organic compounds, the solute having the form of at least one of: a tablet and a powder;
a solvent for dissolving the solute therein to generate a solution; and
an applicator for applying the solution to a surface of a food substance;
wherein the solution substantially inhibits the growth of food borne illness causing organisms.

9. The system of claim 8, wherein the compounds are selected from: citric acid, sodium citrate, vegetable glycerin, sea salt, potassium sorbate, decyl glucoside, calcium ascorbate, grapefruit seed extract, sodium bisulfite, quillaja saponin, ascorbic acid, calcium carbonate, and sodium percarbonate.

10. The system of claim 8, wherein the solute comprises, by weight: 2.4 g of citric acid, 1.2 g of sodium citrate, 1.2 g of quillaja saponin, 0.090 g of ascorbic acid, 0.035 g of calcium carbonate, and 0.075 g of vegetable glycerin.

11. The system of claim 8, wherein the solute comprises, by weight: 2.4 g of citric acid, 1.2 g of sodium citrate, 1.2 g of quillaja saponin, 0.090 g of ascorbic acid, 0.035 g of calcium carbonate, and 0.075 g of vegetable glycerin.

12. The system of claim 8, wherein the solute comprises, by weight: 1.2 g of citric acid, 1.2 g of sodium citrate, 1.2 g of sodium percarbonate, 1.2 g of quillaja saponin, 0.090 g of ascorbic acid, 0.035 g of calcium carbonate, and 0.075 g of vegetable glycerin.

13. The system of claim 8, wherein the solute comprises, by weight: 480 g of citric acid, 240 g of sodium citrate, 240 g of quillaja saponin, 18 g of ascorbic acid, 7 g of calcium carbonate, and 15 g of vegetable glycerin.

14. The system of claim 8, wherein the solute comprises, by weight: 480 g of citric acid, 240 g of sodium citrate, 240 g of sodium percarbonate, 18 g of ascorbic acid, 7 g of calcium carbonate, and 15 g of vegetable glycerin.

15. The system of claim 8, wherein the solute comprises, by weight: 480 g of citric acid, 240 g of sodium citrate, 240 g of sea salt, 18 g of ascorbic acid, 7 g of calcium carbonate, and 15 g of vegetable glycerin.

16. The system of claim 8, wherein the solute comprises, by weight: 480 g of citric acid, 480 g of sodium citrate, 33 g of ascorbic acid, and 7 g of calcium carbonate.

17. The system of claim 8, wherein the solute comprises, by weight: 480 g of citric acid, 240 g of sodium citrate, 240 g of sea salt, 26 g of ascorbic acid, and 14 g of calcium carbonate.

18. The system of claim 8, wherein the solute comprises, by weight: 2.4 g of citric acid, 1.2 g of sodium citrate, 1.2 g of sea salt, 1.2 g of quillaja saponin, 0.090 g of ascorbic acid, 0.035 g of calcium carbonate, and 0.075 g of vegetable glycerin.

19. The system of claim 8, wherein the solute comprises, by weight: 2.4 g of citric acid, 1.2 g of sodium citrate, 1.2 g of sea salt, 0.165 g of ascorbic acid, and 0.035 g of calcium carbonate.
